(19) United States
(12) Patent Application Publication
(10) Pub. No.: US 2015/0143511 A1
(43) Pub. Date: May 21, 2015

(54) SYSTEM AND METHOD FOR HIGH SECURITY BIOMETRIC ACCESS CONTROL

(71) Applicant: VLATACOM D.O.O., Belgrade (RS)

(72) Inventors: Sasa Vujic, Belgrade (RS); Momcilo Majic, Belgrade (RS); Milana Spanovic, Belgrade (RS)

(73) Assignee: VLATACOM D.O.O., Belgrade (RS)

(21) Appl. No.: 14/407,916

(22) PCT Filed: Jun. 13, 2013
(86) PCT No.: PCT/RS2013/000011

§ 371 Date: Dec. 12, 2014

(30) Foreign Application Priority Data
Jun. 14, 2012 (RS) P-2012/0254

(51) Int. Cl. G06F 21/32; G06F 21/34

(52) U.S. Cl. CPC G06F 21/32; G06F 21/34
USPC 726/19

(57) ABSTRACT

System and method for high security biometric access control, according to the invention, enable high security access control to single instance or network resources, using biometric data, smart card technology and public key infrastructure or other symmetric/asymmetric encryption/decryption methodology.

### TECHNICAL FIELD

System and method for high security biometric access control, according to this invention, belongs to security arrangements for protecting computers, components thereof, programs or data against unauthorised activity; to mechanisms actuated by objects other than coins to free or to actuate vending, hiring, coin or paper currency dispensing or refunding apparatus by coded identity card or credit card; to individual entry or exit registers; to methods or arrangements for reading or recognising printed or written characters or for recognising patterns, e.g. fingerprints; record carriers for use with machines and with at least a part designed to carry digital markings at least one kind of marking being used for authentication, e.g. of credit or identity cards; methods or arrangements for recognition using electronic means; record carriers with conductive marks, printed circuits or semiconductor circuit elements, e.g. credit or identity cards; and arrangements for secret or secure communication.

According to the International Patent Classification of (IPC) invention belongs to the class:
G06F 21/00;
G07F 7/08; G07C 9/00
G06K 9/00; G06K 19/10; GO6K 9/62; GO6K 19/067
H04L 9/00

### BACKGROUND ART

System and method for high security biometric access control, according to this invention, solves a problem of the system realization for high security access to individual or networked systems, where is necessary to ensure that unauthorized person cannot access directly to individual or networked resources, neither indirectly using special equipment, while maintaining privacy of authorized users and prevention of other misuses. Resources that are protected are logical such as computers, computer networks, data and programs that are stored on them, but physical resources as well, such as offices, laboratories or buildings that are protected by the doors, gates or ramps etc. In practice, for the access control, different kinds of means are used such as: something that user knows such as password, something that person carries such as key and something that person is, such as biometric characteristics e.g., fingerprint, iris recognition, blood vessel anatomy (layout), voice etc. A simple approach for access protection is password protection that is usually entered using keyboard, sometimes it is only numerical keyboard, so that only Personal Identification Number (PIN) code is entered. The password may be compromised in different ways, and in that case anyone who holds the password can access to the resources. When it comes to resources that person carries with itself, the simplest example is physical key which opens the lock. Although common physical keys are still used, for secure access control different types of digital keys, such as tokens, or cards, are more often used. Contemporary, one of the most secure technologies, which represents key in a digital form, is technology of smart cards. Mechanisms adopted in these cards provide higher level of security. Data recorded in this way can not be changed in unauthorized manner, and it is possible to check data authenticity, while it is not possible to copy the card. Usually smart card is used together with the password, and in that case data cannot be accessed without entering the correct password. In this way misuse of smart card is prevented, if it comes into possession of unauthorized person. As happens in practice, if password is disclosed, the misuse and unauthorized resource access is possible. The aforementioned biometric characteristics are third type of means that are used for access control to the resources and may be used alone, or in combination with others, already mentioned. The most widely used biometric characteristic for access control is fingerprint. The main advantage of biometric characteristics comparing to the other characteristics is the fact that person is always holding them with themselves, and it is very hard to copy or forge them. Nowadays, for high level security control usually biometric characteristics are used, in combination with some other means that are already mentioned. There are implementations of the combined means, but with some drawbacks that are impair their full potential. There are devices with combined resources such as smart card readers with fingerprint scan, that are connected with computer, and all communication between devices goes through computer, so if computer becomes compromised with malware, misuse is possible, such as fingerprint that is coming to the computer, so it can be stored in the period when authorized user is using the system, and misused afterwards by an unauthorized user. Security access means are more and more sophisticated, so misuse is made more difficult, but still is possible. One of the possible misuse scenario, is to underlay a spurious access control device, or to spoof the communication between the access control device and the rest of the system, so that collected information can be later used for unauthorized access. In some systems, data about persons such as reference fingerprint record are stored on a server, or they can be sent to the server for the purpose of comparison, and that can be risk for the security. To diminish the risk, the system and the method for the high security biometric access control is proposed, where fingerprint scanner is used to check the fingerprint of the user that is going to have access to the resources, smart card that contains fingerprint record and implemented algorithm for matching scanned fingerprint, against reference fingerprint, and independent processor unit and memory module which runs these algorithms that are communicating directly with host computer, and where secured resources are stored, and through which user is going to access other secured resources. All of this is connected with security module that stores reference unique hardware identifier of the host computer, system certificate, private and public key, and where unique hardware identifier of the host computer is matched. Typical usage scenario of such systems is within the governmental systems and public administration, security services, big corporations, big infrastructural objects where the main concern is to prevent unauthorized access to individual and networked logical and physical resources.

The need for secure access systems exists for a long time so there is a number of patents that are describing the methods for secure access to individual or networked resources such as:
U.S. Pat. No. 6,256,737 (B1), that describes the system, method and computer program for access control to the resources, using biometric devices, and where reference biometric data are stored on server.
U.S. Pat. No. 6,317,544 (B1), that describes distributed mobile identification system with centralized server and mobile working stations. In this system, referent biometric data are stored on server;
U.S. Pat. No. 6,320,974 (B1), that describes distributed identification system with networked working stations. This system keeps reference biometric data stored on working stations;
U.S. Pat. No. 6,434,259 (B1), that describes methodology for secure access of users to the physical inputs and computer networks, and that is based on a search through stored biometric characteristics on the basis of PIN code;
U.S. Pat. No. 6,681,034 (B1), that describes system and methodology for fingerprint matching, and which includes the use of smart cards where reference fingerprints are stored, and where microprocessor is matching scanned fingerprint against reference fingerprint;
U.S. Pat. No. 6,853,739 (B2), which describes the system for identity verification using biometric characteristics, where the matching is done between scanned data and reference data;
U.S. Pat. No. 6,928,547 (B2), that describes the system and method of user authentication in a computer network, and which combines biometric characteristics with passwords;
U.S. Pat. No. 7,020,308 (B2), that describes biometric system for user authentication that is based on matching between scanned and reference biometric data, with emphasis on methodology that is used for biometric characteristics matching;
U.S. Pat. No. 7,266,224 (B2), that describes device and method for identification of persons, and pass-controller, where face image is used as biometric characteristic, that is matched against reference image stored in memory;
U.S. Pat. No. 7,299,360 (B2), that describes system and method for fingerprint matching, which include utilization of smart cards that are holding reference fingerprints, and where microprocessor is used to match scanned against reference fingerprints;
U.S. Pat. No. 7,330,571 (B2), that describes device and method for biometric verification, and identity registration on the basis of fingerprint;
U.S. Pat. No. 7,454,041 (B2), that describes system for identity recognition, where data about persons are collected and updated, and face image is used as biometric characteristic;
U.S. Pat. No. 7,735,728 (B2), that describes system for access control, that contains data storage reader, data for identification, database and camera that takes pictures of the persons which are matched against the reference images in the data base;
U.S. Pat. App. No. 60/18,739 (A), that describes distributed system for identification of persons on the basis of biometric characteristics of fingerprint and face image;
PCT Pat. App. No. WO2005093993 (A1), that describes device and method for secure access to the equipment, by checking the encrypted reference data with biometric signature taken from the user;
U.S. Pat. App. No. 20100017856 (A1), that describes methodology of biometric access control to the secure computer system, where data about users are stored on server;
U.S. Pat. App. No. 20100242102 (A1), that describes the method of checking biometric data using biometric identification device and system for authentication, and where biometric data are combined with PIN code or password and data checking is done on server;
U.S. Pat. App. No. 20100131765 (A1), that describes method for authentication of users where the anonymous certificates are generated on the basis of public keys;
U.S. Pat. App. No. 20100287369 (A1), that describes system and method for biometric authentication of users, where biometric and other personal data are stored on a device, and the results of comparison are signed digitally before they are sent on a server;
U.S. Pat. App. No. 20110153497 (A1), that describes system and method for secure execution of transactions, where collected biometric characteristics are sent to biometric module on a server and where they are matched against reference biometric characteristics;
U.S. Pat. App. No. 20120042369 (A1), that describes system and method for identification using fingerprint, where smart card integrates module for fingerprint scanning;
U.S. Pat. App. No. 20120054842 (A1), that describes system for secure access control on the basis of matching between scanned biometric characteristics and reference ones that are saved on a cryptographic element, and where single-time access password is generated for access and sent to server for a verification;
U.S. Pat. App. No. 20120054842 (A1), that describes secure identification of users on a host system, where user data are not presented in a explicit form, but only DES encrypted, where DES key is encrypted with PKI encrypted public key, and where validation (checking) is done on server.

### DISCLOSURE OF INVENTION

In the following description, invention is going to be presented in a simplified manner, with a possible implementation. Described implementations are used to explain the main principals of invention, but not to limit the scope of protection, that is given by patent requirements hereinafter.

System and method for high security access control, by invention, solves previously defined problem of system implementation for high security access to a single or networked resources, while keeping the privacy of authorized users, and protecting other possible misuse. In order to access the system, user has to have its own personal smart card whose authenticity is validated using certificates stored in it. The card has user's biometric data such as reference fingerprint of user. User may identify himself by scanning fingerprint that is matched against reference fingerprint. The fingerprint record might be in the form of image, but due to limited resources and faster matching, template of the fingerprint is often used. Fingerprint template stores only the key points of the fingerprint (minutiae). It is important that record on the smart card and the record that is sent to the smart card to be matched are of the same type and that result of matching is supported by smart card. Data on a smart card might be additionally protected by password, that user enters each time when he logs to the system. The misuse of user's biometric data is prevented in a way that biometric data such as fingerprint is stored and checked only on user's smart card and it never leaves the card. The fingerprint that is scanned for matching is forwarded directly to the card, and it never comes in contact with outer communication channels. Beside authentication of smart card and user, system checks authenticity of some of its parts, by checking unique hardware identifier of host computer and workstation certificate that is stored on the system.

Example of possible usage of such system might be in logical access control where logical resources are computer or computer network including data and programs stored on them, and in the physical access control for objects and facilities that are physically protected with doors, gates and ramps and so on. This system is based on methodology of symmetrical/asymmetrical encryption/decryption, and one example of such methodology is Public Key Infrastructure (PKI).

### BRIEF DESCRIPTION OF DRAWINGS

System and method for high security biometric access control, according to this invention, is shown in the accompanying drawings in which reference numbers indicate identical elements of the device and where:

FIG. 1 shows logical block diagram of the system;

FIG. 2 shows access control algorithm;

FIG. 2a shows part of an algorithm for access control that does control of unique hardware identifier of a host computer and validates workstation certificate.

FIG. 2b shows part of algorithm for access control that does optional password verification and validates user's certificate.

FIG. 2c shows part of algorithm for access control that performs fingerprint verification.

FIG. 3 shows part of algorithm that is used for creating workstation certificate;

FIG. 4 shows process of creating workstation certificate and unique hardware identifier of a system;

FIG. 5 shows system that is used for creating user's certificate;

FIG. 6 shows process of creating user's certificate.

### BEST MODE FOR CARRYING OUT OF THE INVENTION

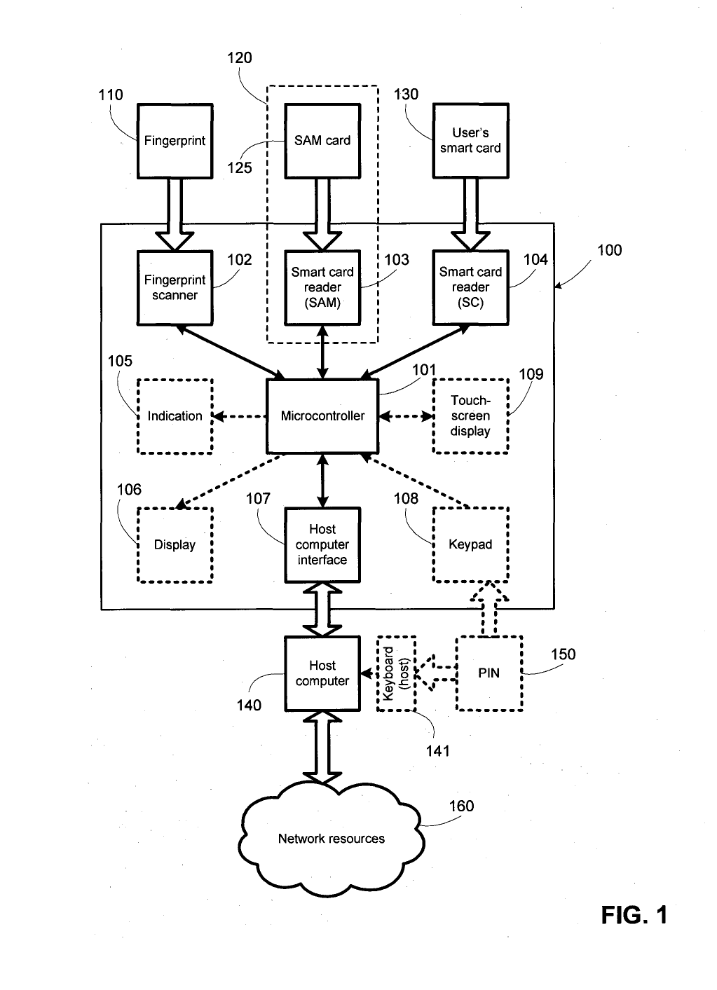

FIG. 1 shows logical block diagram of the system. Integral part of a system is host computer 140 that connects system with networked resources 160. Resources might be logical (computer or computer network, specific data, or programs on a computer or computer network), and physical that includes objects and facilities protected by door, gate or a ramp, whose opening is controlled by biometric access control system. Logical resources might be found on host computer, and they might be network resources. When the network resources are used 160, they are accessed using host computer 140. Central part of the access control block 100 is processing unit with RAM (random-access memory), program memory and communication channels. This part can be implemented in a number of different ways, and FIG. 1 shows implementation using microcontroller 101 that integrates processing unit, RAM, program memory and communication channels. The rest of the block for access control 100 is smart card reader 104, fingerprint scanner 102, the security module 120 and host computer interface 107. Microcontroller communicates with host computer 140 using host computer interface 107, and with user's smart card 130 using smart card reader 104. Interface between smart card reader 104 and user's smart card 130 may be contact or contactless or it can support both types of interface. Security module 120 is used to store workstation certificate, private and public key of the workstation and unique hardware identifier of the host computer. Security module 120 can be used as secure memory for storing the list of authorized users for the certain resources from the workstation. That may be useful in the situations when access to the network computers is needed and information about access privileges of user are on the other computer in the network, and if in that moment computer that is accessed cannot make connection with the rest of the computer network (offline mode). In the FIG. 1 one implementation of security module 120 is shown, using smart card reader for SAM (Security Authentication Module) card reader 103 and SAM card 125. Security module may be implemented as integrated circuit, or as a part of some other integrated circuit such as microcontroller 101. Fingerprint scanner 102 is used for fingerprint scanning 110 of the user who access the system. Fingerprint scanner may be in a form of fingerprint sensor, but it might also be in a form of a module consisting of fingerprint sensor, processor, and RAM. Scanned fingerprint record must be of the same type as reference fingerprint record stored on the card. Since fingerprint sensors capture the image of the fingerprint, if template of the fingerprint is used the conversion to the template is needed. That conversion may be done on the fingerprint scanner 102 if it has its own processing unit, or on microcontroller 101 if only fingerprint sensor is used as scanner.

Integral part of the system is also user's smart card 130 where the personal data about user are stored including the record about reference fingerprint, card certificate, public and private key that are used for cryptographic operations. The user's smart card has its own processing unit that is used for cryptographic operations and matching reference fingerprint against the scanned fingerprint. Optionally, system can have indication 105 to display the procedure, display 106 that is used also to present the results of the procedure, keypad 108 that is used to enter data by user, and optical touch-screen display 109 that is also used to display and to enter data by user. Indication 105 may consist of LED diodes. Keypad may be only numeric, numeric with added special purpose keys, and it may be also the whole alphanumeric keyboard. The keyboard may be used to enter the password, if the password is PIN (Personal Identification Number) code, only numeric keypad is used. To enter data user may use keyboard of the host computer 140 if the host has keyboard.

That implementation is suitable for access control to the logical resources.

Implementation of the system may be done in a several ways. One of the possibilities is that the access control block 100 is in a form of device (with or without indication 105, keypad 108, display 106 and touch-screen display 109) physically separated from the host computer 140. That implementation is suitable for logical access control applications, where resources to be accessed are on the host computer or using host computer network resources are accessed 160. Another possible implementation is to have host computer 140 and access control block integrated in a single device. This implementation is suitable for physical access control applications where resources are mechanism for door opening or ramp lifting.

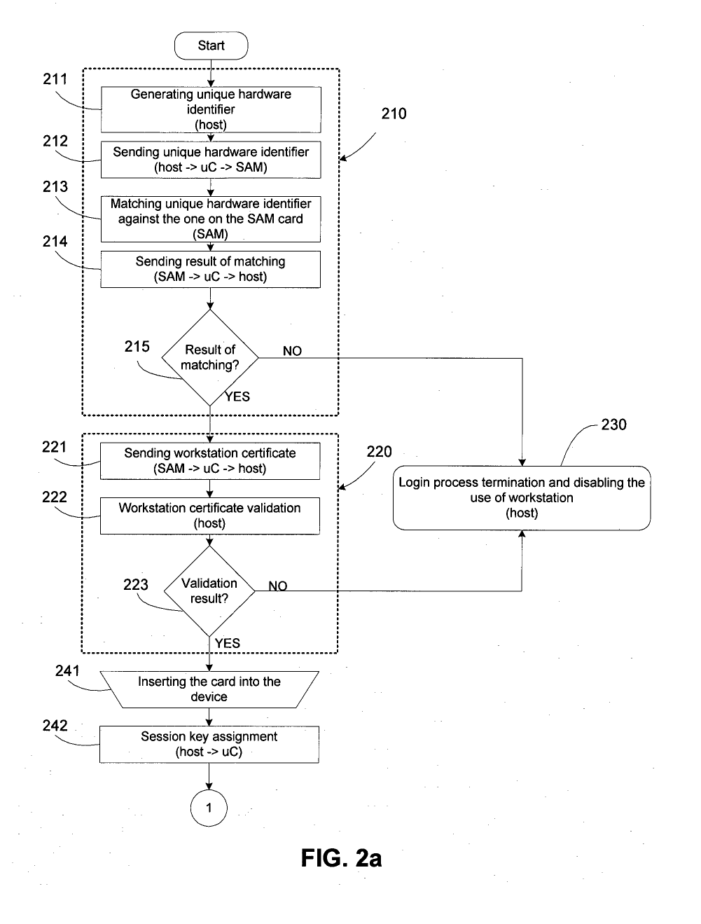

FIG. 2a shows part of access control algorithm that is performing unique hardware identifier matching and workstation certificate validation. Matching of the unique hardware identifier of the host computer 210 is used to control the pairing of the host computers 140, and the access control block 100. The matching procedure begins when host computer generates its own unique hardware identifier 211. Following step is to send aforementioned unique hardware identifier 212 from the host computer 140 to the security module 120 using microcontroller 101. Matching against reference unique hardware identifier 213 is done on the security module 120. Reference hardware identifier is stored on a security module 120 during the initialization procedure. Following step is to send the results of matching 214 from the security module 120 on a host computer 140 using microcontroller 101. If the result of matching 215 is positive, process continues while if the result is negative, login process is terminated and the use of workstation 230 is disabled. If the access procedure of the user is not terminated, workstation certificate validation is done 220. Workstation certificate that is stored on security module 120 is sent 221 from the security module 120 to host computer 140 using microcontroller 101. Host computer 140 does certificate validation 222 and if the result of the validation is positive, process continues, if the result is negative login process is terminated and use of the working station 230 is disabled. Host computer 140 may validate workstation certificate 222 in several ways. One of the possibilities is to do the validation on the entity which is delegated by the certification authority (CA) that issued the certificate and that may be accessed by host using computer network where user is connected. Alternative is that validation procedure is done on the host computer 140 where the list of expired certificates is regularly updated. These lists are used in the offline mode when the computer cannot be connected to computer network. This mode may be used in physical access control application when the host computer is not connected to the computer network. Validation order of unique hardware identifier 210 and working station certificate may be changed. Neither one validation procedure is conditioning the other one but the negative result of any validation procedure terminates login process and disables the use of workstation. If the results of both validation procedures are positive system is waiting for user's smart card 241 to be inserted in user's smart card reader 104. When the user's smart card 130 is inserted, host computer 140 may assign session key 242 by sending it to microcontroller 101. This step is optional and if it is used it is additional factor of security because generated key is used later during digital signing of the results in order to have uniqueness of the message and to avoid any misuse.

FIG. 2b shows password verification 250 and validation of the user's certificate 260. Password verification is optional and it is used if data on user's smart card are protected by password, usually in the form of PIN code, as it is shown in the figure. System requires password entering 251 which is sent from the keypad 108 to user's smart card 130 using microcontroller 101 and smart card reader 104. If the system is using keyboard of the host computer 141, password is sent using host computer 140, microcontroller 101 and smart card reader 104 to user's smart card 130. If entering data into the system is done using touch-screen display 109, password is sent using microcontroller 101 and smart card reader 104 to the user's smart card 130. Password verification 253 is done on user's smart card 130 and if result of verification procedure is positive, user is authorized to access smart card content 254. This step unlocks data about user and gives the right to use fingerprint matching algorithm on the smart card. Next step is sending results of matching 255 from the smart card 130, through microcontroller 101, to the host computer 140. Checking of result of matching is done on the host computer 256. If the result is positive process continues, while if it is negative the session is terminated and smart card removal is required and new insertion of the smart card is needed in order to start a new session. Validation of the user's certificate 260 is necessary. This procedure begins by sending user's certificate 261 from the user's smart card 130 which was issued by CA, using smart card reader 104 and microcontroller 101, to the host computer 140. Validating the card certificate 262 may be done on the host computer and also on the entity delegated by CA that issued the card. In this way, user's smart card 130 authenticity is checked. If the result of the validation is positive 263, process continues, if it is negative, session terminates and card removal is required and new insertion of the card is needed in order to start a new session. If password verification 250 is done, the order of these two validations may be changed. Card certificate is available even if it is locked with a password, so certificate validation 260 may be done before password verification 250.

FIG. 2c shows fingerprint matching procedure 270. Matching starts with fingerprint scanning 271 by fingerprint scanner 102. Next step is sending of scanned fingerprint 272 from the fingerprint scanner 102, using microcontroller and smart card reader 104 to the user's smart card 130. Matching of scanned fingerprint against reference fingerprint 273 is done on user's smart card 130. In this way reference fingerprint that is stored on user's smart card 130, never leaves the card. Fingerprint that is scanned using fingerprint scanner 102 is sent to a user's smart card and it never leaves the access control block 100 and it is never transferred to the host computer 140. In this way high security of the user data is achieved. After the matching reference against scanned fingerprint that has been done on a user's smart card 130, optionally digital signing may be applied. This option is used to prevent the misuse. Digital signing may be done on the user's smart card 130 using user's private key. Part of the message that is signed might be the session key that is previously assigned 242. In that case the message that is signed consists of matching results and session key. In each session the message is going to be different as well as digital signature so in this way misuse is prevented such as recording previous messages and repeating positive responses regardless of the matching results. Digital signing may be done on a security module 120 with the private key of the workstation. In that case is possible to include session key into the message that is signed. Following step is sending of the matching results 275 from the smart card using microcontroller 101 to the host computer 140. If the result of the matching is positive, identity of the user is confirmed and with that the access procedure to the system is concluded. After that host computer 140 decides about granting access to the resources.

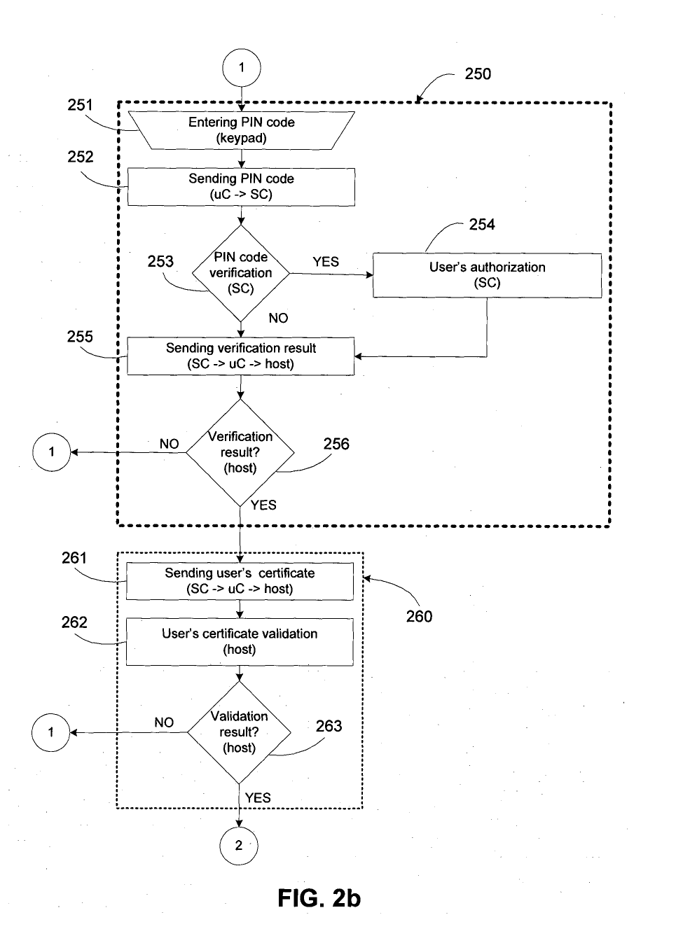

In the FIG. 3 block scheme used to generate station certificate is shown. Parts of that system are security module that is shown in the figure as SAM card 125, but may be in any previously mentioned form, access control block 100, host computer 140 and certification authority (CA) 310. Digital certificate is used to provide high security in the communication between two sides. Owner of the certificate, by sending the certificate, proves its identity to the other side in the communication. CA is entity that issues digital certificates, that is trusted by both sides (trusted third party), owner of the certificate and the one who is relying on that certificate. If the application scenario implies that host computer is connected with CA through computer network whether in the case of physical or logical access control, this process is done during the system initialization, before first logging to the system, generation of the working station certificate is needed, and is stored on the security module.

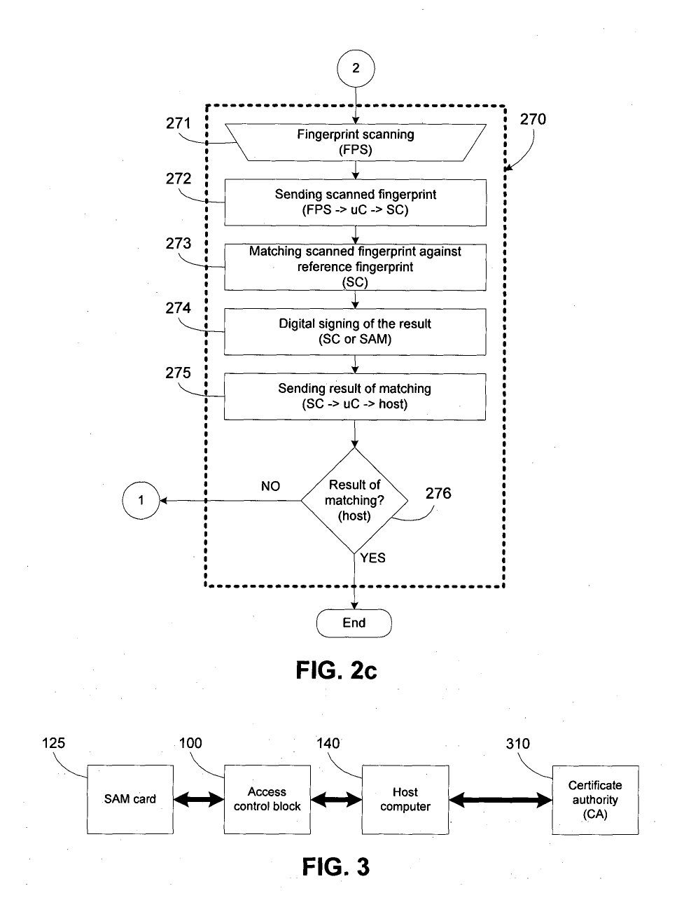

In the FIG. 4 is shown process of creating workstation certificate 410 and storing of unique hardware identifier of the system 420 during the system initialization process. This figure shows procedure that precedes access control and explains the origin of the certificate and keys that are stored on the security module. Generating the pair, public and private key 411 is done on the security module 120. Private or secret key is stored in the place where it is generated, in this case on the security module, and it is not available to anyone except to the owner of the key.

Owner of the key uses its own private key for data encryption and digital signing so in that way is granted that encrypted data, or signed data, are originating from the key owner. Public key is used for data decryption and it is publicly available. The side that is receiving the encrypted or signed message, uses pubic key for decryption, and in that way it confirms that message originates from the owner of the key. In the next step host computer creates certificate signing request 412. Following step is sending of the request 413 from the host computer 140 using microcontroller 101 to security module 120. Security module digitally signs this request 414 with previously generated private key, and after that signed request 415 is sent using microcontroller 101 to the host computer 140. Host computer 140 addresses CA 310 with the request to issue certificate 416. CA 310 generates certificate 417, and it is sent to the host computer 418. Upon receipt of the certificate, the host computer sends certificate 419 using microcontroller to the security module 120. Generating unique hardware identifier 421 is done on the host computer and it is done in a way that host computer writes needed information about its hardware. That is followed by sending unique hardware identifier 422 from the host computer 140 using microcontroller 101 to the security module 120 and storing of the unique hardware identifier on the security module 423.

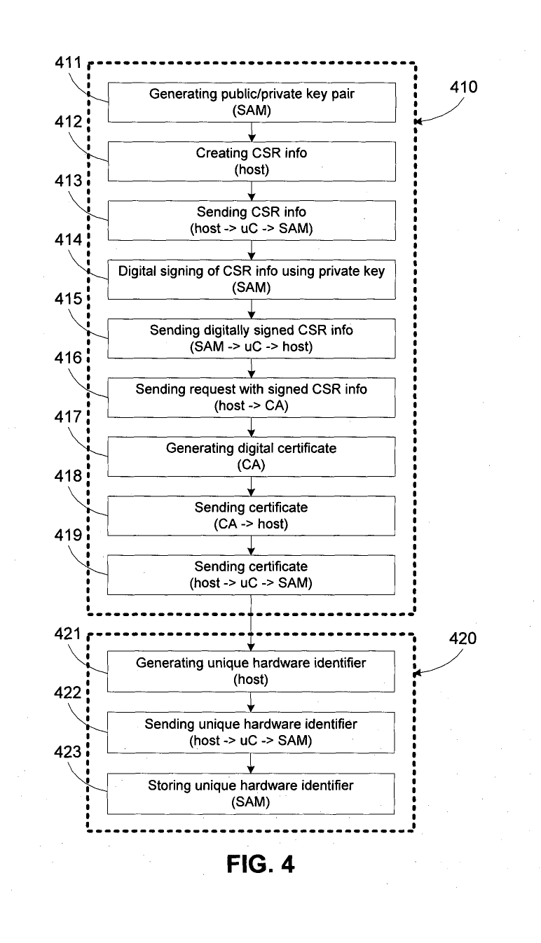

FIG. 5 shows block scheme for creating user's certificate. Parts of the system are user's smart card 130, smart card reader that is used in card production process 510, computer that is used in card production process 520 and CA 310.

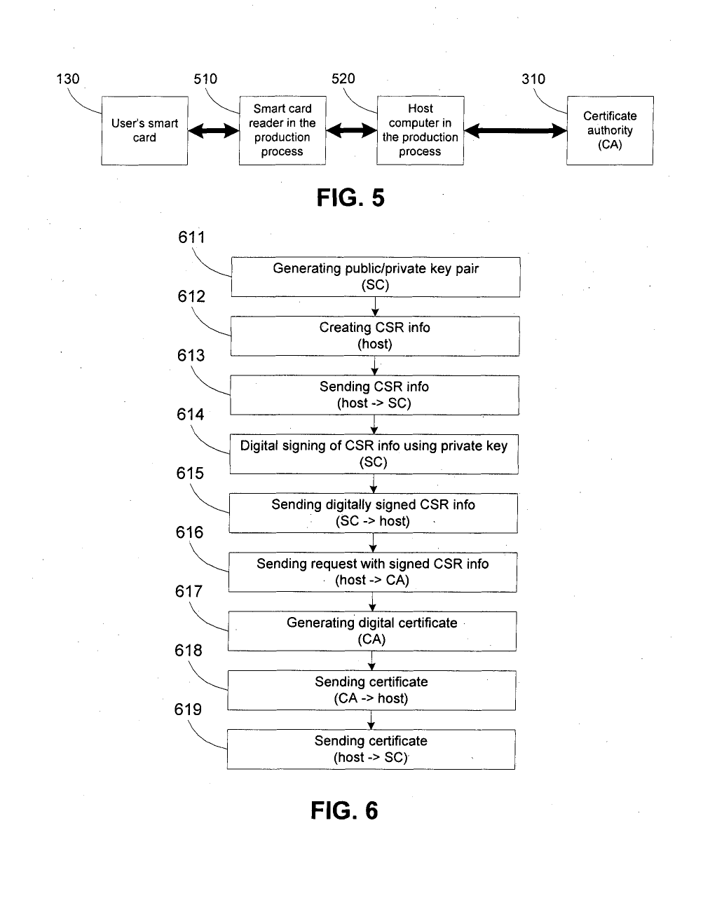

FIG. 6 shows process of creating user's certificate. This process is done before or during the process of smart card personalization. The process starts with generation of public and private keys on a user smart card 611. Host computer, subsequently creates Certificate Signing Request (CSR) 612. Sending of request follows 613 from the computer in production process 520, through smart card reader in production process 510, to the user smart card 130. User smart card digitally signs this request 614 with previously generated private key, and after this signed request 615 is sent, using smart card reader in production process 510, to the computer in the production process 520. Computer 520 addresses CA 310, with the certificate signing request 616. CA 310 creates certificate 617 and sends it to the computer in production process 618. Upon receipt of certificate, the computer sends certificate 619 using smart card reader 510 to the user smart card 130.

### INDUSTRIAL APPLICABILITY

Described system and method for high security biometric access control ensures system implementation for high security access to the individual or networked resources while keeping the privacy of authorized users, and preventing other possible misuse.

1. System for high security access control comprising:
fingerprint scanner for scanning fingerprints of users that are accessing the system;
smart card reader through which system communicates with user smart card;
processor unit for processing, with data memory, program memory and communication channels through which it is connected with fingerprint scanner, smart card reader and host computer;
user's smart card, which includes another processor unit with its own data and program memory, where user certificate is stored and data about user, including record about reference fingerprint, and where matching scanned fingerprint against reference fingerprint is done;
host computer where protected resources are stored and accessed by user, and used for access to the other protected resources,
wherein the data about referent unique hardware identifier of a host computer, system certificate, public and private key, are stored in security module, and where the unique hardware identifier matching against said referent unique hardware identifier is done.

2. System for high security biometric access control of claim 1, wherein communication channel between user's smart card and smart card reader is contactless.

3. System for high security biometric access control of claim 1 or 2, wherein described system contains optical display that is used for display of messages dedicated to user.

4. System for high security biometric access control, of claim 3, wherein described system contains keyboard that is used for data entering by user of the system.

5. System for high security biometric access control, of claim 3 or 4 wherein optical display is touch-screen display with data entry functionality.

6. System for high security biometric access control of claim 1, wherein security module stores list of the users that are allowed to enter the system.

7. Method for high security biometric access control, wherein matching unique hardware identifier with unique reference hardware identifier that is stored on security module is done, and check of the system certificate is done, thus if both checks are successful further user certificate validation and matching of scanned fingerprint against reference fingerprint that is stored on the user's smart card is done.

8. The method for high security biometric access control of claim 7, wherein user's data are stored on user's smart card protected by password, which check is required after checking unique hardware identifier of host computer and system certificate, and if password check is not successful user access is denied.

9. The method for high security biometric access control of claim 7, wherein the message about result of matching scanned fingerprint, of the user who is accessing the system, against reference fingerprint that is stored on a user's smart card that is forwarding, is digitally signed by private key of the user's smart card.

10. The method for high security biometric access control of claim 7, wherein the message about result of matching scanned fingerprint of the user who is accessing the system, against reference fingerprint that is stored on user's smart card, that is being forwarded to the host computer, is digitally signed by private key of the system that is stored on a security module.

11. The method for high security biometric access control of claim 9 or 10, wherein the host computer is assigning the session key, that can be used as a part of digitally signed message about result of matching scanned fingerprint of the user who is accessing the system, against reference fingerprint that is stored on user's smart card, which provides uniqueness of the message and increased security of the access control method.

12. The method for high security biometric access control of claim 7, wherein certificate validation is done locally on the host computer.

13. The method for high security biometric access control of claim 7, wherein certificate validation is done on certificate authority connected to the local host.

14. The method for high security biometric access control of claim 7, wherein after successful validation of fingerprint for user that is accessing to the system, access approval is done on host computer.

15. The method for high security biometric access control of claim 7, wherein after successful fingerprint validation of the user who is accessing the system, access approval is done on security module of system on the basis of the list of users that have authorized access.
